(19) United States
(12) Patent Application Publication
(10) Pub. No.: US 2019/0340904 A1
(43) Pub. Date: Nov. 7, 2019

(54) Door Surveillance System and Control Method Thereof

(71) Applicant: Hangzhou Eyecloud Technologies Co., Ltd., Hangzhou (CN)

(72) Inventors: Po Yuan, San Jose, CA (US); Shengjun Pan, Pengzhou (CN); Junneng Zhao, Hangzhou (CN); Daniel Mariniuc, Giroc, Timis (RO)

(21) Appl. No.: 16/503,452

(22) Filed: Jul. 3, 2019

Related U.S. Application Data
(63) Continuation-in-part of application No. 16/078,253.

(30) Foreign Application Priority Data
May 7, 2018 (CN) 2019103733740
Jun. 29, 2018 (CN) PCT/CN2018/093697

(51) Int. Cl. G08B 13/196; H04N 7/18; G06K 9/32; G06K 9/00; H04N 5/247; G06N 3/02; G07C 9/00

(52) U.S. Cl. CPC G08B 13/19695; H04N 7/186; G06K 9/3233; G06K 9/00536; G06K 9/00362; G07C 9/00182; H04N 5/247; H04N 7/188; G06N 3/02; G07C 9/00896; G06K 9/00228

(57) ABSTRACT

A door surveillance system is adapted for implementing remote interaction between a visiting object and an owner of a property's premise and monitoring the area proximate to the door remotely. The door surveillance system comprises an interaction interface configured to receive an interaction request operation. Upon detecting an interaction request of the visiting object, at least a portion of the image data of the visiting object is outputted for transmission to the remote computing device along with the interaction request, thereby enabling the visiting object to interact with the owner of the property' premise. Automatic transmission of the image data of the visiting object facilitates door surveillance to help ensure personal and property's premise.

### CROSS REFERENCE OF RELATED APPLICATION

This is a Continuation-In-Part application that claims the benefit of priority under 35 U.S.C. § 120 to a non-provisional application, application number U.S. Pat. No. 16/078,253 filed Date Aug. 21, 2018 which is a U.S. National Stage under 35 U.S.C. 371 of the International Application Number PCT/CN2018/093697 filed Date Jun. 29, 2018. This is also a non-provisional application that claims the benefit of priority under 35 U.S.C. § 119 (A-D) to a Chinese patent application, application number 2019103733740.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to door surveillance system, and more particular to a door surveillance system with artificial intelligence and capable of implementing remote interaction for a visiting object who wants to interact with an owner of a property' premise.

### Description of Related Arts

Door surveillance system plays an increasingly important role in protecting human's personal and property's safety. Currently, the mainstream door surveillance system is motion-triggered door surveillance system that activates the function of video surveillance in response to a presence of object motion. However, such door surveillance system encounters many drawbacks in practice.

First of all, any object with moving ability is able to trigger the door surveillance system, that is, the motion-triggered surveillance system fails to distinguish whether the object detected in the field of view thereof is a desired object or not. For instance, a dog or cat (animal with moving ability) interrupting into the monitoring areas of the door surveillance system would also trigger the door surveillance system which would also generate an alert signal to notify the registered persons, causing great annoyances.

In addition, a portion of the moving objects standing in front of the door is the one who desires to interact with the owner (such as a visitor). However, such interaction request can only be satisfied when the owner is present in the property's premise. For example, a visitor is able to trigger an interaction request to the owner by pressing a doorbell to ask for a door unlock, and if the owner is not in the property's promise, such interaction request cannot be satisfied. In other words, the conventional door surveillance system lacks of remote interaction functionality.

Consequently, there is an urgent desire for a door surveillance system which enables remote interaction a visiting object who wants to interact with the owner of the property' premise.

### SUMMARY OF THE PRESENT INVENTION

The invention is advantageous in that it provides a door surveillance system and control method thereof, wherein the door surveillance system comprises a camera system, installed at a peephole of a door of a premise' property, configured for capturing image data for a visiting object proximate to the door within the field of view thereof. The image data of the visiting object is then processed and analyzed with artificial intelligence algorithms to determine whether one or more criteria are satisfied. At least a portion of the image data of the visiting object is selectively outputted, in response to determining that one or more criteria are satisfied, for transmission to a remote computing device, such that the owner of the property's premise is enabled to monitor the area proximate to door. The door surveillance system further comprises an interaction interface configured to receive an interaction request operation. Upon detecting an interaction request of the visiting object, at least a portion of the image data of the visiting object is outputted for transmission to the remote computing device of the owner along with the interaction request, thereby enabling the visiting object to interact with the owner of the property' premise. The interaction request in the present disclosure includes but not limited to door unlock request, voice call request, and video call request.

According to one aspect of the present invention, it provides a door surveillance system, which comprises:

a camera system positioned at a peephole of a door of a property' premise, wherein the camera system comprises a motion detector configured to detect an object motion within the field of view of the camera system, and a first camera device facing towards an outer side of the door and configured to capture image data of the visiting object in the area at the outer side proximate to the door;

an interaction interface positioned at the peephole of the door and configured to receive an interaction request from the visiting object;

a door controller comprising at least one processor and one or more storage devices, wherein the one or more storage device encoded with instructions that, when executed by the at least one processor, cause the at least one processor to:

determine, by a door controller processing at least a portion of the image data of the visiting object, that any one of one or more criteria are satisfied, wherein the one or more criteria comprises determining that the objects contained in the image data includes human being, and determining that the image data contains human face region;

output, in response to determining that any one of one or more criteria are satisfied, at least a portion of image data of the visiting object for transmission to a remote computing device; and

output, in response to receiving an interaction request from the visiting object, at least a portion of image data of the visiting object and the interaction request for transmission to the remote computing device.

In one embodiment of the present invention, the interaction request comprises a video call request, a voice call request and a door unlock request.

In one embodiment of the present invention, the instructions that, when executed by the at least one processor, cause at least one processor to: receive, by the door controller from the remote computing device, an unlock control command configured to cause the door controller to unlock an electronically-controlled door lock of the door; and, unlock, by the door controller in response to receiving the unlock control command from the remote computing device, the electronically-controlled door lock so as to remotely open the door of the property's premise via the remote computing device.

In one embodiment of the present invention, the camera system further comprises a second camera device positioned at the peephole of the door opposite to the first camera device and facing towards an inner side of the door, wherein the second camera device is configured to capture image data of the visiting object in the area at the inner side proximate to the door.

In one embodiment of the present invention, the instructions that, when executed by the at least one processor, cause the door controller to: determine, by a door controller processing the image data of the visiting object with a first deep neural network model, whether the objects contained in the image data includes human being; determine, by the door controller processing the image data of the visiting object with a second deep neural network model, that the image data contains human face region; and in response to determining that the objects contained in the image data includes human being, or determining that the image data contains human face region, determine that any one of one or more criteria are satisfied.

In one embodiment of the present invention, the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

In one embodiment of the present invention, instructions that, when executed by the at least one processor, cause at least one processor to: identify different image regions between a first and a second image of the image data; group the different image regions between the first image and the second image into one or more regions of interest (ROIs); transform the one or more ROIs into grayscale; classify, by processing the grayscale ROIs with the first deep neural network model, the objects contained in the one or more ROIs; and determine whether the objects contained in the one or more ROIs includes human being.

In one embodiment of the present invention, instructions that, when executed by the at least one processor, cause the door controller to: identify different image regions between a first and a second image of the image data; group the different image regions between the first image and the second image into one or more regions of interest (ROIs); transform the one or more ROIs into grayscale; and determine, by processing the grayscale ROIs with the second deep neural network model, whether the image data contains human face region.

According to another aspect of the present invention, it further provides a control method, comprising the following steps.

Detect an object motion in the field view of a camera system including a first camera device, wherein the camera system is positioned at a peephole of a door of a property's premise.

Capture, by the camera system in response to detecting an object motion in the field view thereof, an image data of the visiting object.

Receive, by an interaction interface, an interaction request from the visiting object.

Determine, by a door controller processing the image data of the visiting object, that any one of one or more criteria are satisfied, wherein the one or more criteria comprises determining that the objects contained in the image data includes human being, and determining that the image data contains human face region.

Output, in response to determining that one or more criteria are satisfied, at least a portion of image data of the visiting object for transmission to a remote computing device.

Output, in response to receiving the interaction request from the visiting object, at least a portion of the image data of the visiting object and the interaction request for transmission to the remote computing device.

In one embodiment of the present invention, the interaction request comprises door unlock request, wherein the control method further comprises the following steps.

Receive, by the door controller from the remote computing device, an unlock control command configured to cause the door controller to unlock an electronically-controlled door lock of the door.

Unlock, by the door controller in response to receiving the unlock control command from the remote computing device, the electronically-controlled door lock so as to open the door of the property's premise.

In one embodiment of the present invention, the camera system further comprises a second camera device positioned at the peephole of the door opposite to the first camera device and facing towards an inner side of the door, wherein the second camera device is configured to capture image data of the visiting object in the area at the inner side proximate to the door.

In one embodiment of the present invention, wherein the step of determining, by a door controller processing the image data of the visiting object, that any one of one or more criteria are satisfied, comprises the following steps.

Determine, by a door controller processing the image data of the visiting object with a first deep neural network model, whether the objects contained in the image data includes human being.

Determine, by the door controller processing the image data of the visiting object with a second deep neural network model, whether the image data contains human face region.

Determine, in response to determining that the objects contained in the image data includes human being, or determining that the image data contains human face region, that any one of one or more criteria are satisfied.

In one embodiment of the present invention, the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

In one embodiment of the present invention, the step of determining, by a door controller processing the image data of the visiting object with a first deep neural network model, whether the objects contained in the image data includes human being, comprises the following steps.

Identify different image regions between a first and a second image of the image data.

Group the different image regions between the first image and the second image into one or more regions of interest (ROIs).

Transform the one or more ROIs into grayscale.

Classify, by processing the grayscale ROIs with the first deep neural network model, the objects contained in the one or more ROIs.

Determine whether the objects contained in the one or more ROIs includes human being.

In one embodiment of the present invention, the step of determining, by the door controller processing the image data of the visiting object with a second deep neural network model, whether the image data contains human face region, comprises the following steps.

Identify different image regions between a first and a second image of the image data.

Group the different image regions between the first image and the second image into one or more regions of interest (ROIs).

Transform the one or more ROIs into grayscale.

Determine, by processing the grayscale ROIs with the second deep neural network model, whether the image data contains human face region.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a door surveillance system according to a preferred embodiment of the present invention.

FIG. 2 is another schematic view of the door surveillance system according to a modification mode of the preferred embodiment of the present invention.

FIG. 3 is a schematic view illustrating a camera system, an interaction interface and an optical door viewer are integrally configured in a peephole of the door according to the above preferred embodiment of the present invention.

FIG. 4 is another schematic view illustrating a camera system, an interaction interface and an optical door viewer integrally are configured in a peephole of the door according to a modification mode of the preferred embodiment of the present invention.

FIG. 5 is a flow diagram illustrating the process of determining whether the objects contained in the image data includes human being by a door controller processing the image data of the visiting object with a first deep neural network model according to the above preferred embodiment of the present invention.

FIG. 6 is a flow diagram illustrating the process of determining whether the image data contains human face region, by the door controller processing the image data of the visiting object with a second deep neural network model, according to the above preferred embodiment of the present invention.

FIG. 7 is a flow diagram of a control method according to the above preferred embodiment of the present invention.

### DETAILED DESCRIPTION OF THE PREFERRED EMBODIMENT

In this disclosure, it provides a door surveillance system adapted for implementing remote interaction between a visiting object and an owner of a property's premise and monitoring the area proximate to the door remotely. Accordingly, the door surveillance system comprises a camera system, positioned at a peephole of the door of the premise' property, configured to capture image data of a visiting object proximate to the door within the field of view thereof. The image data of the visiting object is then processed and analyzed with artificial intelligence algorithm to determine whether any one of one or more criteria are satisfied. Upon determining that any one of the one or more criteria are satisfied, at least a portion of the image data of the visiting object is outputted, for transmission to a remote computing device, such that the owner of the property's premise is enabled to monitor the area proximate to door remotely via the portable computing device. Moreover, the door surveillance system further comprises an interaction interface configured to receive an interaction request operation. Upon detecting an interaction request of the visiting object, at least a portion of the image data of the visiting object is outputted for transmission to the remote computing device along with the interaction request, thereby enabling the visiting object to interact with the owner of the property' premise. In particular, the camera system and the interaction interface in the present invention are integrally installed at the peephole of the door, such that the overall aesthetic appearance of the door can be maintained while the camera system is protectively hidden in the peephole.

In this disclosure, the interaction request in the present disclosure includes but is not limited to a door unlock request, a voice call request, and a video call request. In other words, the visiting object is able to remotely interact with the owner of the property's premise to conduct, but is not limited to, a voice call, a video call and a request for unlocking the door.

In this disclosure, the one or more criteria comprises determining that the objects contained in the image data includes human being and determining that the image data contains human face region. In particular, the people detection and the face detection are performed with artificial intelligence algorithm using a specific deep neural network (DNN) model that is able to achieve a good trade-off between computational cost and detection precision. Since the image data of the visiting object is controllably and selectively recorded and then transmitted to the remote computing device based on the detection results of the people detection and the face detection, erroneous image-data transmission to the computing device can be effectively reduced, so that the power consumption of the door surveillance system can be minimized. Moreover, the DNN model adopted in this disclosure has a relatively smaller model size that can be employed in a programmable terminal chip, facilitating its application in terminal products.

Illustrative Door Surveillance System

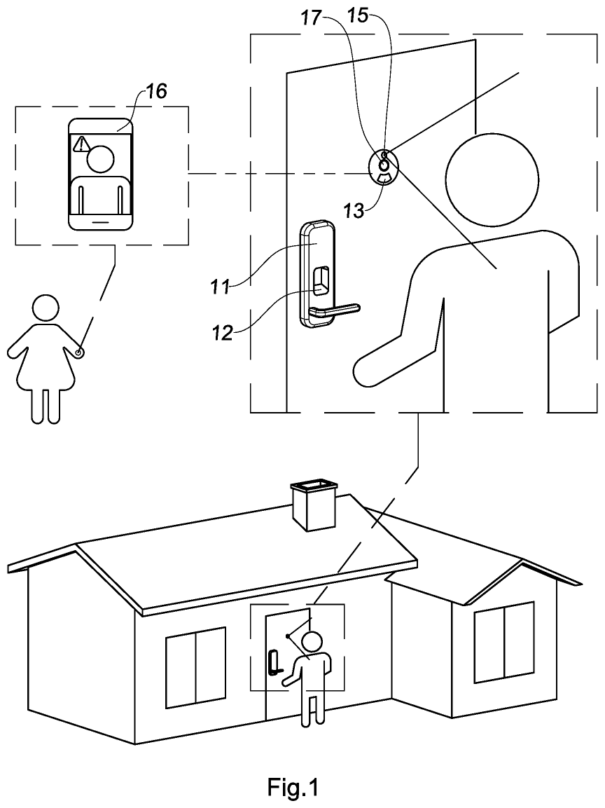

Referring to FIG. 1 of the drawings, a door surveillance system according to a preferred embodiment of the present invention is illustrated, wherein the door surveillance system comprises an electronically-controlled door lock 11, a door lock control interface 12, an interaction interface 13, a door controller 14, a camera system 15, and a computing device 16.

As shown in the FIG. 1 of the drawings, the electronically-controlled door lock 11 is installed at a door of a property's premise and can be selectively actuated between a locked and unlocked position to control an opening and closing of the door. The door lock control interface 12, communicatively linked to the electronically-controlled door lock 11, is adapted for implementing a security check mechanism for the electronically-controlled door lock 11 in such a manner that upon the security check is succeeded, the electronically-controlled door lock 11 is actuated to its unlock position to unlock and open the door. For instance, the door lock control interface 12 may include a keypad (e.g., a numeric keypad, an alphanumeric keypad, or another keypad interface) configured to receive an entrance code (e.g., from the owner) for selectively actuating the electronically-controlled door lock 11 between a locked position and an unlocked position in response to receiving a candidate entrance code that matches an unlock code. In certain examples, the door lock control interface 12 may include a voice-recognition, fingerprint recognition, retinal scan recognition, facial recognition or other biometric interface to implement the security check mechanism for selectively controlling the actuation of the electronically-controlled door lock 11.

It is worth mentioning that the door lock control interface 12 may be installed at any position of the door, e.g, integrally provided at a position of the electronically-controlled door lock 11, or separately mounted at a position of the door proximate to the electronically-controlled door lock 11.

The camera system 15 is integrally installed at the door and configured to capture image data of a visiting object in the area proximate to the door within the field of view thereof. As shown in the example of FIG. 1 of the drawings, the camera system 15 is integrally configured in a peephole 220 of the door while exposing its optical lens (es) to the external for capturing the image data within the field of view thereof. In this way, the camera system 15 integrated in the peephole 220 of the door can be considered as a door video monitoring system (DVMS) for monitoring the area proximate to the door especially the area proximate to the electronically-controlled door lock 11. From another perspective, the camera system 15 integrated in the peephole 220 of the door can also be regarded as an electronic door viewer (comparable to the conventional optical door viewer 17 installed at the peephole 220 of the door) for monitoring the area proximate to the door.

It is worth mentioning that since the camera system 15 is integrated in the peephole 220 of the door, the aesthetic appearance of the door can be maintained, while the camera system 15 in the peephole 220 of the door is well-protected to substantially prolong its life span.

The camera system 15 in this disclosure can include a motion detector 151 and one or more camera devices, wherein the motion detector 151 is configured to detect an object motion in the field of view of the one or more camera devices. The one or more camera devices is configured to capture (e.g., sense) image data (e.g., video image data, still image data, or other types of image data) of the visiting object in the area proximate to the door in the field of view thereof in response to detecting an object motion by the motion detector 151. In other words, the motion detection result obtained by the motion detector 151 is utilized as a activation signal to activate the one or more cameras device to operate so as to capture the image data of the visiting object in the area proximate to the door in the field of view thereof. Therefore, the camera system 15 in the present disclosure has two operation modes: standby mode and operation mode. In the standby mode, only the motion detector 151 is activated to detect object motion in the field of view of the camera system 15, while the camera system 15 is switched to its operation mode in response to detecting an object motion by the motion detector 151 in the field of view of the camera system 15, that the one or more camera devices starts to capture image data of the visiting object in the area proximate to the door in the field of view thereof. In this way, the power consumption of the camera system 15 can be substantially reduced.

As shown in the FIG. 1 of the drawings, the one or more camera devices comprises a first camera device 153 installed in the peephole 220 of the door, wherein the first camera device 153 faces towards an outer side of the door, and is configured to capture image data of the visiting object at the outer side of the door. More specifically, the first camera device 153 has a first field of view covering a predetermined area range outside the door, such as an area extending from the door to within five feet, ten feet, or other distances from the door, such that when an object motion is detected in the field of view of the first camera device 153 by the motion detector 151, the first camera device 153 is activated to capture the image data of the visiting object outside the door. In other words, the first camera device 153 in the present disclosure can be regarded as an outdoor video surveillance device to monitor the area proximate to and at an outer side of the door.

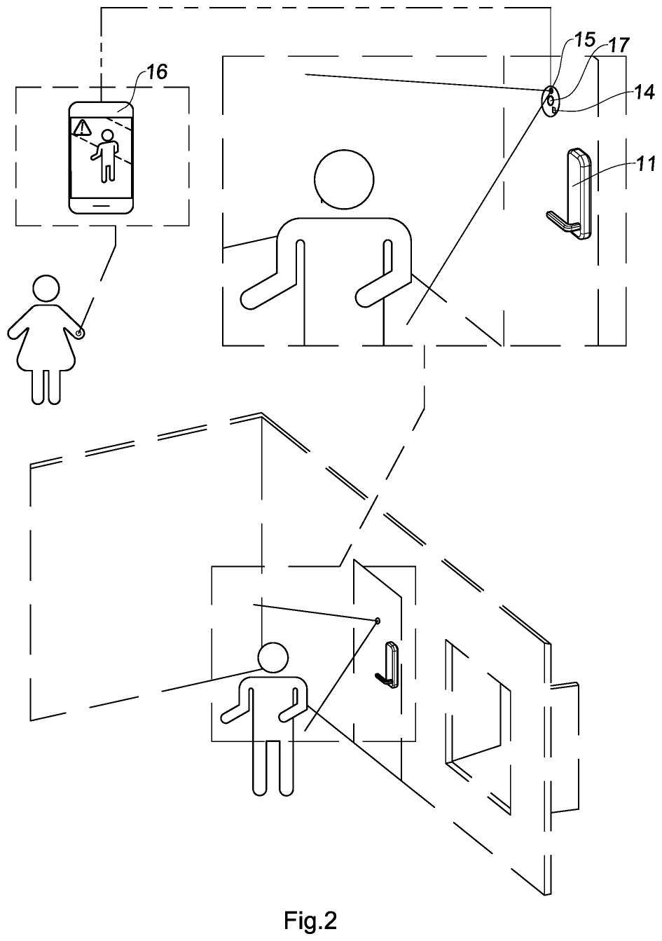

Referring to FIG. 2 of the drawings, a modification mode of the camera system 15 according to the above preferred embodiment of the present invention is illustrated, wherein the one or more camera devices further comprises a second camera device 155 integrally installed at the peephole of the door opposite to the first camera device 153, wherein the second camera device 155 faces towards an inner side of the door and is configured to capture image data of the visiting object at the inner side proximate to the door. Accordingly, the second camera device 155 has a second field of view covering an area range at the inner side of the door, such as an area extending from the door to within five feet, ten feet, or other distances from the door, such that when an object motion is detected in the field of view of the second camera device 155, the second camera device 155 is activated to capture the image data of the visiting object in the area inside the door in the field of view thereof. In other words, the second camera device 155 can be regarded as an indoor video surveillance device to monitor the area proximate to and at an inner side of the door.

In other words, the door surveillance system may include two camera devices (e.g., the first camera device 153 and the second camera device 155) with one camera device facing towards an inner side of the door which is being activated by indoor motions to monitor indoor area proximate to the door of the property's premise, and the other camera device facing towards an outer side of the door which is being activated by outdoor motions to monitor the outdoor area proximate to the door of the property's premise.

It is worth mentioning that while illustrated in the examples of FIG. 1 and FIG. 2 as including one or two camera device, in other examples, the one or more camera device may include more than two camera devices. For instance, the camera system 15 can further include a third camera device (not shown in the drawings) installed in the peephole 220 of the door at a position i.e. lower or higher than the first camera device 153, such the first camera device 153 and the third camera device have a different field of view and incorporate with each other to maximize the overall viewing range of the camera system 15. It is appreciated that the third camera device facing towards an outer side of the door may has a field of view equal to/different from the first field of view of the first camera device 153, which is not intended to be limiting in the present disclosure.

The camera devices (i.e the first camera device 153, the second camera device 155 or the third camera device) in the present invention can be and/or include any image capturing sensor and/or device configured to capture (e.g., sense) image data (e.g., video and/or still image data) in digital and/or analog form in response to an object motion being detected in the field of view of the camera system 15. The camera devices can store a threshold amount of image data within a data buffer, such as a circular (or ring) buffer that stores a threshold amount of image data corresponding to a threshold time period, such as a thirty seconds, five minutes, or other threshold time periods. In certain examples, the data buffer can be stored at computer-readable memory of the door controller 14.

Accordingly, the door controller 14 in the present disclosure comprises one or more processors and one or more storage devices encoded with instructions that, when executed by the one or more processor, cause the door controller 14 to implement functionality of a control method according to the techniques described below. For instance, the door controller 14 can be a terminal processing device positioned at the door and electronically and/or communicatively coupled with the camera system 15 for receiving the image data from the camera system 15 and then outputting the image data for transmission to a remote computing device 16 in response to determining that any one of the one or more criteria are satisfied, as is further described below.

Examples of the one or more processors of the door controller 14 can include any one or more of a microprocessor, a controller, a digital signal processor (DSP), an application specific integrated circuit (ASIC), a field-programmable gate array (FPGA), or other equivalent discrete or integrated logic circuitry. Examples of one or more storage device can include a non-transitory medium. The term “non-transitory” can indicate that the storage medium is not embodied in a carrier wave or a propagated signal. In certain examples, a non-transitory storage medium can store data that can, over time, change (e.g. in RAM or cache). In some examples, the storage devices are a temporary memory, meaning that a primary purpose of the storage devices is not long-term storage. The storage devices, in some examples, are described as a volatile memory, meaning that the storage devices do not maintain stored contents when power to communication and lock switching controller is turned off. Examples of volatile memories can include random access memories (RAM), dynamic random access memories (DRAM), static random access memories (SRAM), and other forms of volatile memories. In some examples, the storage devices are used to store program instructions for execution by the one or more processors of door controller 14. The storage devices, in certain examples, are used by software applications running on door controller 14 to temporarily store information during program execution.

During operation, the image data of the visiting object captured and recorded by the camera system 15 is processed and analyzed by the door controller 14 with a specific algorithm to determine whether any one of the one or more criteria are satisfied. Example one or more criteria can include the objects contained in the image data including human being and the image data containing human face region. In other words, the door controller 14 in present invention is adapted to implement people detection and face detection on the image data of the visiting object. As one example of operation, if no criterion is satisfied in the detection step, no further action will the door controller 14 perform and the camera system 15 is arranged to turn back to its standby mode that only the motion detector 151 is activated to detect object motion in the field of view of the camera system 15. Instead, the door controller 14 is configured to output at least a portion of the image data captured by the camera system 15 for transmission, via a wireless communication network, to the computing device 16 remote from the door and communicatively linked with the door controller 14. In certain examples, the transmitted image data can include buffered data, such as buffered video data, a starting time of the buffered video data corresponding to a threshold time period prior to determining that the one or more alert criteria are satisfied, such as a threshold time period of thirty seconds, one minute five minutes, thirty minutes, or other threshold time periods.

Examples of remote computing device 16 includes but not limited to desktop computers, laptop computers, tablet computers, mobile phones (including smart phone), personal digital assistants, or other computing device 16. Example wireless communication network can include, e.g., any one or more of a satellite communications (SATCOM) network, a cellular communications network, a wireless interne (e.g., WiFi) communications network, a radio frequency (RF) communications network, or other types of wireless communication networks. In general, wireless communication network can be any wireless communication network that enables door controller 14 to send and receive data with a remote computing device 16, such as the remote computing device 16.

In particular, the specific algorithm for people detection and face detection on the image data in the present invention is constructed based on artificial intelligence. For instance, the door controller 14 may utilize the motion-based object detection method as disclosed in application U.S. Ser. No. 16/078,253 to process the image data of the visiting object to determine whether the objects contained in the image data includes human being.

Accordingly, the motion-based object detection method comprises the following steps. First, a first and a second image of the image data are processed in order to extract one or more regions of the interest (ROIs) therefrom. In the present invention, the region of interest (ROI) refers to an image segment which contains a candidate object of interest in image processing technology. Since the object contained in the image data to be processed is a moving object, the ROIs can be extracted by identifying the moving parts between the images collected by camera system 15. For purposes of clarity and ease of discussion, such ROI extraction method is defined as motion-based ROI extraction method.

From the perspective of image representation, the moving parts are the image segments having different image contents between images. Therefore, at least two images (a first image and a second image) are required in order to identify the moving parts in the images by a comparison between the first image and the second image. In other words, the image data to be processed in the door controller 14 comprises at least two image frames (e.g., the first image and the second image). It is noted that the first and second images of the image data are captured by the camera system with same image background (the door area) and the differences between the first image and the second image indicates the visiting objects in the image data. Therefore, the one or more ROIs can be formed by clustering the moving parts of the image data into the one or more larger ROIs. In other words, image segments with different image content between the first image and the second image are grouped to form the larger ROIs.

The two image frames may be captured by the camera system 15 at a predetermined time interval, such as 0.5 s. It is appreciated that the time interval between the two image frames of the image data can be set at any value in the present invention.

For example, the first and the second images may be picked up from a video data (with a predetermined time window, such as 15 s) collected by the camera system 15 and more particularly, the first and the second images could be two consecutive frames in the video data. In other words, the time interval of the first and the second image may be set as the frame rate of the video data.

It is important to mention that during capturing the image data of the visiting object, an unwanted movement (such as translation, rotation and scaling) may occur to the camera devices of the camera system 15, causing an offset on the backgrounds in the first and the second images. Accordingly, effective measures should be taken to compensate for the physical movement of the camera devices prior to identifying the moving parts in the first and second images. For instance, the second image can be transformed to align the background in the second image with that in the first image in order to compensate for the unwanted physical movement based on the position data provided by a positioning sensor (i.e, gyroscope) integrated in the respective camera device.

It is important to mention that the ROI is less in size than an entirety of the first image or the second image, such that the computational cost of a first DNN model to process the one or more ROIs is significantly reduced from the data source aspect.

In order for further reducing the computational cost, the one or more ROIs are transformed into grayscale, that is, the one or more ROIs are grey processed to transform into grayscale. Those who skilled in the art would understand that normal images are colorful images such as in RGB format or YUV format fully representing the features (including illumination and color features) of the imaged object. However, the color feature doesn't do that much help in classifying the candidate objects contained in the ROIs, or even unnecessary in some applications. The purpose of gray processing the

ROIs is to filter the color information in the ROIs so as to not only reduce the computational cost of the DNN model but also to effectively prevent the color information adversely affecting object detection accuracy.

In order to further minimize the computational cost of the first DNN model, the one or more ROIs may be scaled to particular sizes, i.e 128*128 pixels. In practice, the size reduction of ROIs depends on the accuracy requirement of the people detection and the model architecture of the first DNN model. In other words, the scaled size of the ROIs can be adjusted corresponding to the complexity of the first DNN model and the accuracy requirements of people detection, which is not a limitation in this disclosure.

Further, the one or more grayscale ROIs are inputted into the first DNN model and processed to classify the objects contained in the one or more ROIs and to determine whether the objects contained in the one or more regions include human being.

More specifically, the first DNN model in this disclosure is constructed based on the depthwise separable convolution layers, wherein the depthwise separable convolution layer uses depthwise separable convolution in place of standard convolution to solve the problems of low computational efficiency and large parameter size. The depthwise separable convolution is a form of factorized convolution which factorize a standard convolution into a depthwise convolution and a 1×1 convolution called a pointwise convolution, wherein the depthwise convolution applies a single filter to each input channel and the pointwise convolution is used to create a linear combination the output of the depthwise convolution to obtain updated feature maps. In other words, each depthwise separable convolution layer comprises a depthwise convolution layer for applying a single filter to each input channel and a pointwise layer for linearly combining the outputs of the depthwise convolution layer to obtain a feature map.

The first DNN model comprises N depthwise separable convolution layers, wherein the N is a positive integer and ranged from 4-12. In practice, the number of the depthwise separable convolution layers is determined by the requirements for latency and accuracy in specific scenarios. In particular, the first DNN model may comprises five depthwise separable convolution layers (listed as first, second, third, fourth and fifth depthwise separable convolution layers), wherein the grayscale ROIs are inputted into the first depthwise separable convolution layer.

More detailedly, the first depthwise separable convolution layer comprises 32 filters of size 3—3 in the depthwise convolution layer and filters of size 1×1 in a corresponding number in the pointwise convolution layer. The second depthwise separable convolution layer connected to the first depthwise separable convolution layer comprises 64 filters of size 3×3 in the depthwise convolution layer and filters of size 1×1 in a corresponding number in the pointwise convolution layer. The third depthwise separable convolution layer connected to the second depthwise separable convolution layer comprises 128 filters of size 3×3 in the depthwise convolution layer and filters of size 1×1 in a corresponding number in the pointwise convolution layer. The fourth depthwise separable convolution layer connected to the third depthwise separable convolution layer comprises 256 filters of size 3×3 in the depthwise convolution layer and filters of size 1×1 in a corresponding number in the pointwise convolution layer. The five depthwise separable convolution layer connected to the fourth depthwise separable convolution layer comprises 256 filters of size 3×3 in the depthwise convolution layer and filters of size 1×1 in a corresponding number in the pointwise convolution layer

After obtaining the feature maps from the grayscale ROIs by a predetermined number of depthwise separable convolution layers, the candidate objects contained in the grayscale ROIs are further classified by the first DNN model and a classification result based on a determination of whether the objects contained in the ROIs includes human being. In particular, the deed of classifying the candidate objects contained in the grayscale ROIs is accomplished by a Softmax layer of the first DNN model.

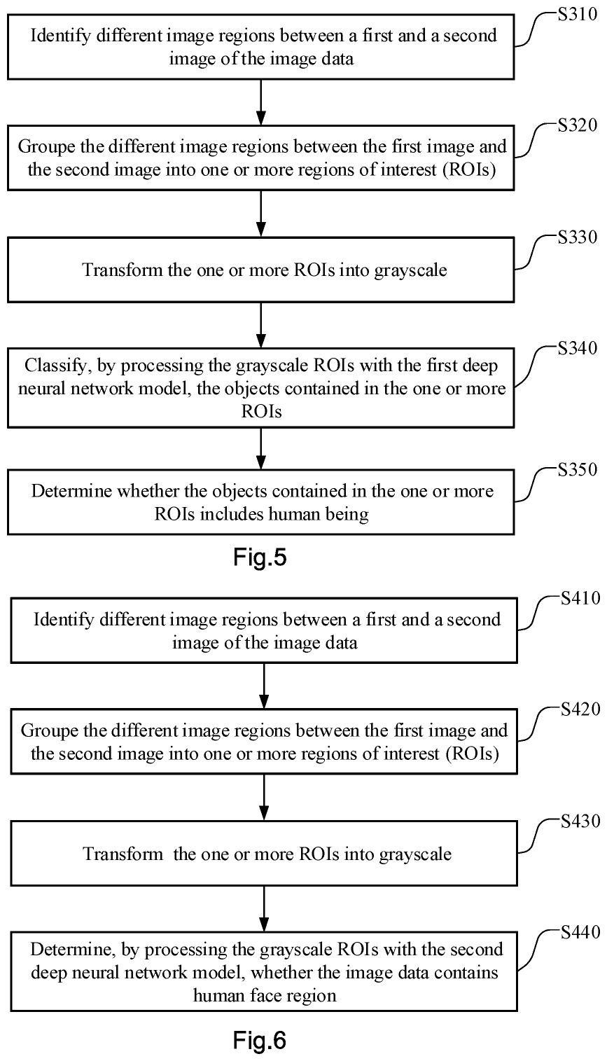

The process of determining, by the door controller 14 processing the image data with a first DNN model, whether the objects contained in the image data includes human is illustrated. FIG. 5 is a flow diagram illustrating the process of determining whether the objects contained in the image data includes human being by a door controller processing the image data of the visiting object with a first deep neural network model according to the above preferred embodiment of the present invention. As shown in the FIG. 5 of the drawings, this determining process comprises the following steps of: S310, identifying different image regions between a first and a second image of the image data; S320, grouping the different image regions between the first image and the second image into one or more regions of interest (ROIs); S330, transforming the one or more ROIs into grayscale; S340, classifying, by processing the grayscale ROIs with the first deep neural network model, the objects contained in the one or more ROIs; and S350, determining whether the objects contained in the one or more ROIs includes human being.

As method above, the one or more criteria further includes determining that the image data contains human face region. Similarly, the specific algorithm adopted for processing the image data for face detection is also based on artificial intelligence.

More specifically, the door controller 14 could also learn from the spirit of the motion-based object detection method as disclosed in application U.S. Ser. No. 16/078,253 to process the image data to determine whether the image data contains human face region.

For instance, the image data can be firstly processed using the aforementioned motion-based ROI extraction method to extract one or more ROIs from the image data.

Then, the one or more ROIs are transformed into grayscale in order to reduce the computational costs of a second DNN model (to be discussed below). Since the process of ROI extraction and grayscaling are consistent with those of the people detection, detailed description is eliminated in the present invention. After that, the one or more grayscale ROIs are inputted into the second DNN model in which the one or more grayscale ROIs are processed to determine whether the image data contains human face region.

In particular, the second DNN model may have a same model architecture with the first DNN model, that is, the second DNN model may also be constructed based on the depthwise separable convolution layers. In other words, the first DNN model and the second DNN model in this disclosure can be constructed with same model architecture but with different model parameters, such that the model compression techniques can be utilized when storing the first and second DNN model in the storage device of the door controller 14.

FIG. 6 is a flow diagram illustrating the process of determining whether the image data contains human face region, by the door controller processing the image data of the visiting object with a second deep neural network model, according to the above preferred embodiment of the present invention. As shown in the FIG. 6 of the drawings, this determining process comprises the following steps of: S410 identifying different image regions between a first and a second image of the image data; S420, grouping the different image regions between the first image and the second image into one or more regions of interest (ROIs); S430, transforming the one or more ROIs into grayscale; and, S440, determining, by processing the grayscale ROIs with the second deep neural network model, whether the image data contains human face region.

It is worth mentioning that the deep neural network (DNN) models used for implementing the people detection and the face detection is able to achieve a good trade-off between computational cost and detection precision. Furthermore, the DNN models adopted in this disclosure has a relatively smaller model size that can be directly employed in the door controller 14, thereby facilitating the application of DNN models in portable and/or terminal products.

It is worth mentioning that the door controller 14 may utilize other people detection and face detection methods to process the image data of the visiting object so as to determine whether the objects contained in the image data includes human being and whether the image data contains human face region, which is not intended to be limiting in the present invention.

As it is mentioned above, upon determining that at least one of the one or more criteria are satisfied, the door controller 14 outputs at least a portion of the image data of the visiting object for transmission to the remote computing device 16, so that the owner of the property's premise is able to review the recorded image data to monitor the area proximate to the door and further selectively determine to interact with the visiting object.

For instance, when the owner finds the visiting object is ill-intentioned, he/she may send alert information to the visiting object via the remote computing device 16. When the owner thinks the visiting object is safe and trustful enough (e.g., a friend or family member of the owner), he/she may inquiry the visiting object whether it is needed to unlock the door via the remote computing device 16, and after confirming a door unlock request, the owner may agree to transmit an unlock control command to the door lock controller, wherein upon receiving the unlock control command, the door controller 14 actuates the electronically-controlled door lock 11 to its unlocking state to open the door for the visiting object remotely. It is appreciated that the interaction mode between the owner and the visiting object is not intended to be limiting to the examples as illustrated above.

It should be easily understood that the visiting object coming to the door of the property's premise typically carries a specific purpose and thus intends to interact with the owner of property's premise. In order to fully meet this potential need, the door surveillance system in this present disclosure further comprise an interaction interface 13 configured to receive an interaction request operation from the visiting object. Upon detecting an interaction request of the visiting object by the interaction interface 13, the door controller 14 outputs at least a portion of the image data of the visiting object together with the interaction request for transmission to the remote computing device 16. In other words, the door surveillance system in the present disclosure is able to implement the remote interaction functionality that enables the visiting object to remotely interact with the owner of the property's premise. In certain examples, the interaction request includes but is not limited to voice call request, video call request, and door unlock request.

In an example of the present disclosure, the interaction request is embodied as a voice call request. Accordingly, a voice call request and at least a portion of the image data of the visiting object are outputted, in response to the interaction interface 13 being activated, via the door controller 14 for transmission to the remote computing device 16, such that the visiting object is able to make a voice call with the owner of the property's premise once the request is confirmed.

In another example of the present invention, the interaction request is embodied as a video call request. Accordingly, a video call request and at least a portion of the image data of the visiting object are outputted, in response to the interaction interface 13 being activated, via the door controller 14 for transmission to the remote computing device 16, such that the visiting object is able to make a video call with the owner of the property's premise once the request is confirmed.

In another example of the present invention, the interaction request is embodied as a door unlock request. Accordingly, a door unlock request and at least a portion of the image data of the visiting object are outputted, in response to the interaction interface 13 being activated, via the door controller 14 for transmission to the remote computing device 16, such that the owner of the property's premise is able to view and review object contained in the image data to evaluate whether the visiting object is safe and trustful enough to transmit an unlock control command. Upon receiving the unlock control command, the door controller 14 actuates the electronically-controlled door lock 11 to its unlocking state to open the door for the visiting object remotely.

It is worth mentioning that the interaction interface 13 in the present invention may include, but is not limited to, touch-control interface, voice-control interface, gesture control interface and etc. In particular, the interaction interface 13 is integrally positioned at the peephole 220 of the door, together with the camera system 15 and a conventional door viewer 17.

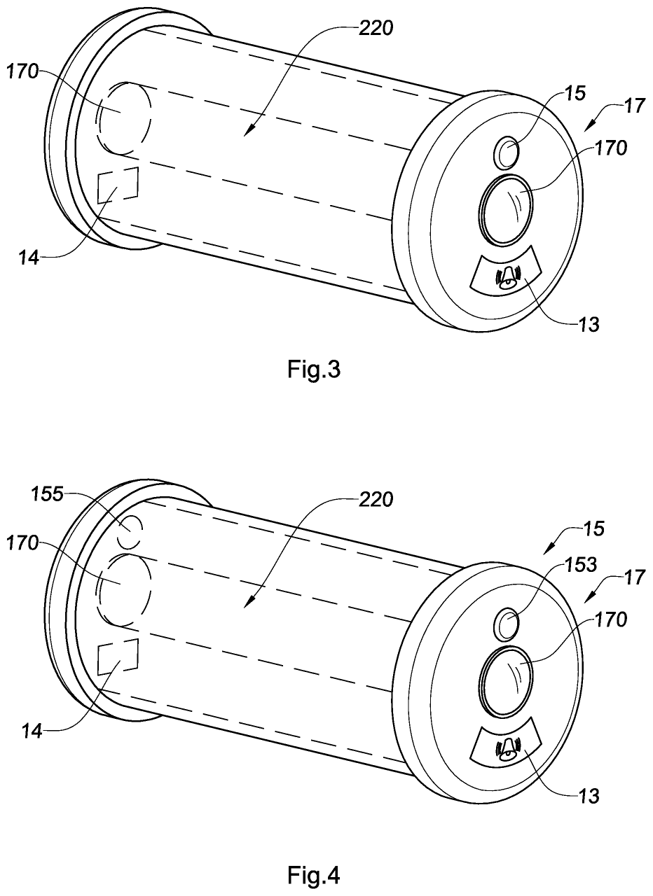

As shown in the FIG. 3 of the drawings, the interaction interface 13, the camera system 15 and the conventional optical door viewer 17 are integratedly installed in the peephole 220 of the door, wherein the optical door viewer 17 comprises two optical lens 170 provided at two opposed sides of the peephole 220 of the door respectively. As shown in the FIG. 3 of the drawings, the camera 15 merely includes the first camera device 153 installed at an upper portion of the optical lens 170 at the outer side of the door, while the interaction interface 13 is installed at a lower portion of the corresponding optical lens 170, such that when the visiting object actuates the interaction interface 13 to issue the interaction request, the first camera device 153 is directly facing towards the visiting object to capture the image data of the visiting object effectively. It is important to mention that other necessary components may also be integratedly configured in the peephole 220, such as a power source (not shown in the Figures).

As mentioned above, since the door controller 14 adopts a DNN model with a novel model architecture to perform the people detection and/or face detection on the image data of the visiting object, and the camera devices 153, 155 of the camera system 15 are activated to normally operate in response to detecting an object motion by the motion detector 151, the camera system 15 and the door controller 13 have a relatively low power-consumption. In particular, a portable battery is able to fulfill the power consumption requirements of the door surveillance system.

FIG. 4 is another schematic view illustrates that a camera system, an interaction interface and an optical door viewer are integrally configured in a peephole of the door according to the preferred embodiment of the present invention. As shown in FIG. 4, the camera system 15 comprises the first camera device 153 and the second camera device 155, wherein the first camera device 153 is installed at an upper portion of the optical lens 170 at the outer side of the door, while the second camera device 155 is installed at an upper portion of the optical lens 170 at the inner side of the door. Similarly, the interaction interface 13 is installed at a lower portion of the respective optical lens at the outer side of the door, such that when the visiting object actuates the interaction interface 13 to issue the interaction request, the first camera device 153 is directly facing towards the visiting object to capture the image data of the visiting object effectively. It is important to mention that other necessary components may also be integratedly configured in the peephole 220, such as a power source (not shown in the Figures).

Similarly, since the door controller 14 adopts a DNN model with a novel model architecture to perform the people detection and/or face detection on the image data of the visiting object, and the camera devices 153, 155 of the camera system 15 are activated to normally operate in response to detecting an object motion by the motion detector 151, the camera system 15 and the door controller 13 have a relatively low power-consumption. In particular, a portable battery is able to fulfill the power consumption requirements of the door surveillance system.

In particular, the portable battery may be installed at a lower portion of the optical lens 170 at the inner side of the door and is electrically linked with the second camera device 155 to supply electrical power for it. In addition, the first camera 151 may also be powered by the portable battery via a wiring extended therebetween along the peephole 220. It is appreciated that laying the wiring between the two opposed optical lenses 170 along the peephole 220 is quite easy and convenient.

During operation, upon receiving the interaction request from the visiting object (i.e. the visiting object press the doorbell of the interaction interface 13), the door controller outputs at least a portion of the image data of the visiting object for transmission to the remote computing device 16 along with the interaction request, such that the owner can review the recorded image data to evaluate the objects contained therein, and to determine whether to interact with the visiting object or not.

In summary, this disclosure provides a door surveillance system adapted for implementing remote interaction between a visiting object and an owner of a property's premise and monitoring the area proximate to the door remotely. Accordingly, the door surveillance system comprises a camera system, positioned at a peephole of the door of the premise' property, configured to capture image data of a visiting object proximate to the door within the field of view thereof. The image data of the visiting object is then processed and analyzed with artificial intelligence algorithm to determine whether any one of one or more criteria are satisfied. Upon determining that any one of the one or more criteria are satisfied, at least a portion of the image data of the visiting object is outputted, for transmission to a remote computing device, such that the owner of the property's premise is enabled to monitor the area proximate to door remotely via the portable computing device. Moreover, the door surveillance system further comprises an interaction interface configured to receive an interaction request operation. Upon detecting an interaction request of the visiting object, at least a portion of the image data of the visiting object is outputted for transmission to the remote computing device along with the interaction request, thereby enabling the visiting object to interact with the owner of the property' premise. In particular, the camera system and the interaction interface in the present invention are integrally installed at the peephole of the door, such that the overall aesthetic appearance of the door can be maintained while the camera system is protectively hidden in the peephole.

In particular, the interaction request in the present disclosure includes but is not limited to a door unlock request, a voice call request, and a video call request. In other words, the visiting object is able to remotely interact with the owner of the property's premise to conduct, but is not limited to, a voice call, a video call and a request for unlocking the door.

In particular, the camera system 15 and the interaction interface 13 in the present invention are integrally configured in the peephole 220 of the door, such that the overall aesthetic appearance of the door can be maintained while the camera system 15 is hidden in the peephole 220 for protection purpose.

Illustrative Control Method

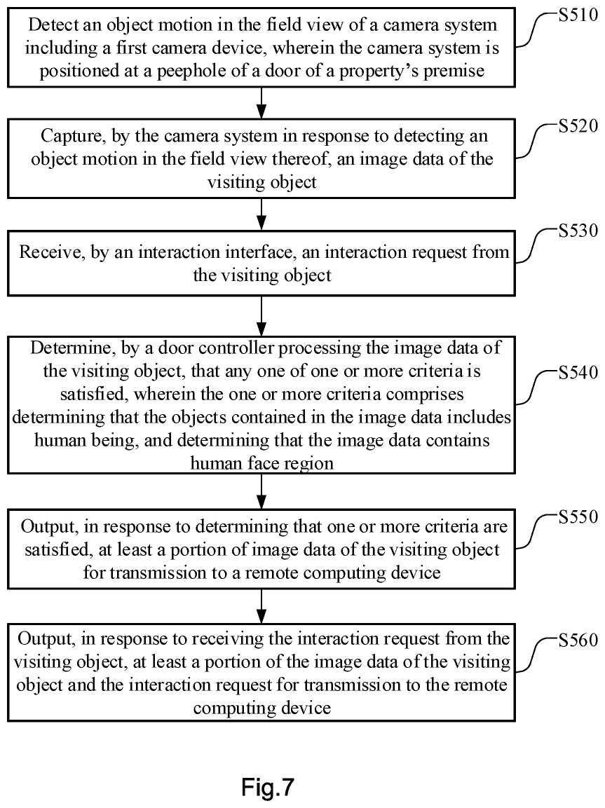

Referring to the FIG. 7 of the drawings, a control method according to the above preferred embodiment of the present invention is illustrated, wherein the control method comprises the following steps.

S510, Detect an object motion in the field view of a camera system including a first camera device, wherein the camera system is positioned at a peephole of a door of a property's premise.

S520, Capture, by the camera system in response to detecting an object motion in the field view thereof, an image data of the visiting object.

S530, Receive, by an interaction interface, an interaction request from the visiting object.

S540, Determine, by a door controller processing the image data of the visiting object, that any one of one or more criteria are satisfied, wherein the one or more criteria comprises determining that the objects contained in the image data includes human being, and determining that the image data contains human face region.

S550, Output, in response to determining that one or more criteria are satisfied, at least a portion of image data of the visiting object for transmission to a remote computing device. and

S560, Output, in response to receiving the interaction request from the visiting object, at least a portion of the image data of the visiting object and the interaction request for transmission to the remote computing device.

In one embodiment of this disclosure, the control method further comprises the following steps.

Receive, by the door controller from the remote computing device, an unlock control command configured to cause the door controller to unlock an electronically-controlled door lock of the door.

Unlock, by the door controller in response to receiving the unlock control command from the remote computing device, the electronically-controlled door lock so as to open the door of the property's premise.

In one embodiment of the present invention, the camera system further comprises a second camera device positioned at the peephole of the door opposite to the first camera device and facing towards an inner side of the door, wherein the second camera device is configured to capture image data of the visiting object in the area at the inner side proximate to the door.

In one embodiment of the present invention, wherein the step of determining, by a door controller processing the image data of the visiting object, that any one of one or more criteria are satisfied, comprises the following steps.

Determine, by a door controller processing the image data of the visiting object with a first deep neural network model, whether the objects contained in the image data includes human being.

Determine, by the door controller processing the image data of the visiting object with a second deep neural network model, whether the image data contains human face region.

Determine, in response to determining that the objects contained in the image data includes human being, or determining that the image data contains human face region, that any one of one or more criteria are satisfied.

In one embodiment of the present invention, the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

In one embodiment of the present invention, the step of determining, by a door controller processing the image data of the visiting object with a first deep neural network model, whether the objects contained in the image data includes human being, comprises the following steps.

Identify different image regions between a first and a second image of the image data.

Group the different image regions between the first image and the second image into one or more regions of interest (ROIs).

Transform the one or more ROIs into grayscale.

Classify, by processing the grayscale ROIs with the first deep neural network model, the objects contained in the one or more ROIs.

Determine whether the objects contained in the one or more ROIs includes human being.

In one embodiment of the present invention, the step of determining, by the door controller processing the image data of the visiting object with a second deep neural network model, whether the image data contains human face region, comprises the following steps.

Identify different image regions between a first and a second image of the image data.

Group the different image regions between the first image and the second image into one or more regions of interest (ROIs).

Transform the one or more ROIs into grayscale.

Determine, by processing the grayscale ROIs with the second deep neural network model, whether the image data contains human face region.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A door surveillance system, comprising:
a camera system positioned at a peephole of a door of a property' premise, wherein the camera system comprises a motion detector configured to detect an object motion within the field of view of the camera system, and a first camera device facing towards an outer side of the door and configured to capture image data of the visiting object in the area at the outer side proximate to the door; and
an interaction interface positioned at the peephole of the door and configured to receive an interaction request from the visiting object; and
a door controller comprising at least one processor and one or more storage devices, wherein the one or more storage device encoded with instructions that, when executed by the at least one processor, cause the at least one processor to:
determine, by a door controller processing at least a portion of the image data of the visiting object, that any one of one or more criteria are satisfied, wherein the one or more criteria comprises determining that the objects contained in the image data includes human being, and determining that the image data contains human face region;
output, in response to determining that any one of one or more criteria are satisfied, at least a portion of image data of the visiting object for transmission to a remote computing device; and
output, in response to receiving an interaction request from the visiting object, at least a portion of image data of the visiting object and the interaction request for transmission to the remote computing device.

2. The door surveillance system, as recited in claim 1, wherein the interaction request comprises a video call request, a voice call request and a door unlock request.

3. The door surveillance system, as recited in claim 2, wherein the instructions that, when executed by the at least one processor, cause at least one processor to:
receive, by the door controller from the remote computing device, an unlock control command configured to cause the door controller to unlock an electronically-controlled door lock of the door; and
unlock, by the door controller in response to receiving the unlock control command from the remote computing device, the electronically-controlled door lock so as to remotely open the door of the property's premise via the remote computing device.

4. The door surveillance system, as recited in claim 1, wherein the camera system further comprises a second camera device positioned at the peephole of the door opposite to the first camera device and facing towards an inner side of the door, wherein the second camera device is configured to capture image data of the visiting object in the area at the inner side proximate to the door.

5. The door surveillance system, as recited in claims 1, wherein the instructions that, when executed by the at least one processor, cause at least one processor to:
determine, by the door controller processing the image data of the visiting object with a first deep neural network model, whether the objects contained in the image data includes human being;
determine, by the door controller processing the image data of the visiting object with a second deep neural network model, that the image data contains human face region; and
determining, in response to determining that the objects contained in the image data includes human being, or determining that the image data contains human face region, that any one of one or more criteria are satisfied.

6. The door surveillance system, as recited in claim 5, wherein the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

7. The door surveillance system, as recited in claim 6, wherein instructions that, when executed by the at least one processor, cause at least one processor to:
identify different image regions between a first and a second image of the image data;
group the different image regions between the first image and the second image into one or more regions of interest (ROIs);
transform the one or more ROIs into grayscale;
classify, by processing the grayscale ROIs with the first deep neural network model, the objects contained in the one or more ROIs; and
determine whether the objects contained in the one or more ROIs includes human being.

8. The door surveillance system, as recited in claim 6, wherein instructions that, when executed by the at least one processor, cause at least one processor to:
identify different image regions between a first and a second image of the image data;
group the different image regions between the first image and the second image into one or more regions of interest (ROIs);
transform the one or more ROIs into grayscale; and
determine, by processing the grayscale ROIs with the second deep neural network model, whether the image data contains human face region.

9. A control method, comprising the steps of:
detecting an object motion in the field view of a camera system including a first camera device, wherein the camera system is positioned at a peephole of a door of a property's premise;
capturing, by the camera system in response to detecting an object motion in the field view thereof, an image data of the visiting object;
receiving, by an interaction interface, an interaction request from the visiting object;
determining, by a door controller processing the image data of the visiting object, that any one of one or more criteria are satisfied, wherein the one or more criteria comprises determining that the objects contained in the image data includes human being, and determining that the image data contains human face region;
outputting, in response to determining that one or more criteria are satisfied, at least a portion of image data of the visiting object for transmission to a remote computing device; and
outputting, in response to receiving the interaction request from the visiting object, at least a portion of the image data of the visiting object and the interaction request for transmission to the remote computing device.

10. The control method, as recited in claim 8, further comprising the steps of:
receiving, by the door controller from the remote computing device, an unlock control command configured to cause the door controller to unlock an electronically-controlled door lock of the door; and
unlocking, by the door controller in response to receiving the unlock control command from the remote computing device, the electronically-controlled door lock so as to open the door of the property's premise.

11. The control method, as recited in claim 9, wherein the camera system further comprises a second camera device positioned at the peephole of the door opposite to the first camera device and facing towards an inner side of the door, wherein the second camera device is configured to capture image data of the visiting object in the area at the inner side proximate to the door.

12. The control method, as recited in claim 10, wherein the step of determining, by a door controller processing the image data of the visiting object, that any one of one or more criteria are satisfied, comprises the steps of:
determining, by the door controller processing the image data of the visiting object with a first deep neural network model, whether the objects contained in the image data includes human being;
determining, by the door controller processing the image data of the visiting object with a second deep neural network model, whether the image data contains human face region; and
determining, in response to determining that the objects contained in the image data includes human being, or determining that the image data contains human face region, that any one of one or more criteria are satisfied.

13. The control method, as recited in claim 12, wherein the first deep neural network model and the second deep neural network model comprises N (N is a positive integer and ranged from 4-12) depthwise separable convolution layers respectively, wherein each depthwise separable convolution layer comprises a depthwise convolution layer for applying a single filter to each input channel and a pointwise layer for linearly combining the outputs of the depthwise convolution layer to obtain feature maps of the image data.

14. The control method, as recited in claim 13, wherein the step of determining, by a door controller processing the image data of the visiting object with a first deep neural network model, whether the objects contained in the image data includes human being, comprises the steps of:
identifying different image regions between a first and a second image of the image data;
grouping the different image regions between the first image and the second image into one or more regions of interest (ROIs);
transforming the one or more ROIs into grayscale;
classifying, by processing the grayscale ROIs with the first deep neural network model, the objects contained in the one or more ROIs; and
determining whether the objects contained in the one or more ROIs includes human being.

15. The control method, as recited in claim 13, wherein the step of determining, by the door controller processing the image data of the visiting object with a second deep neural network model, whether the image data contains human face region, comprises the steps of:
identifying different image regions between a first and a second image of the image data;
grouping the different image regions between the first image and the second image into one or more regions of interest (ROIs);
transforming the one or more ROIs into grayscale; and
determining, by processing the grayscale ROIs with the second deep neural network model, whether the image data contains human face region.
